(19) United States
(12) Patent Application Publication
(10) Pub. No.: US 2026/0190161 A1
(43) Pub. Date: Jul. 2, 2026

(54) RULES FOR NON-PRIMARY CHANNEL ACCESS SWITCH

(71) Applicant: QUALCOMM Incorporated, San Diego, CA (US)

(72) Inventors: Gaurang NAIK, San Diego, CA (US); Abhishek Pramod PATIL, San Diego, CA (US); George CHERIAN, San Diego, CA (US); Alfred ASTERJADHI, San Diego, CA (US); Sai Yiu Duncan HO, San Diego, CA (US); Sherief HELWA, San Diego, CA (US); Giovanni CHISCI, San Diego, CA (US); Sanket Sanjay KALAMKAR, San Diego, CA (US)

(21) Appl. No.: 19/002,605

(22) Filed: Dec. 26, 2024

(51) Int. Cl. H04W 74/08; H04W 28/02

(52) U.S. Cl. CPC H04W 74/0866; H04W 28/0278

(57) ABSTRACT

Aspects of the present disclosure provide methods for wireless communication at a wireless node, generally including detecting, on a first primary channel, a first frame that conveys a response that is part of an initial control frame exchange; and performing a switch to a second primary channel, wherein a timing of the switch is based on at least one rule that depends on whether the apparatus also had detected, on the first primary channel, a second frame that solicited the response.

### TECHNICAL FIELD

This disclosure relates generally to wireless communication, and more specifically, to rules for switching to a non-primary channel.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some WLAN scenarios, devices share access to a wireless medium. In such scenarios, contention-based channel access is a mechanism used to share the wireless medium. This mechanism allows multiple devices to access the same wireless channel without a centralized coordinator, making it suitable for scenarios with a variable number of devices.

For example, devices that want to transmit data first listen to the wireless channel. This procedure is referred to as carrier sensing, where a device first checks if the channel is idle or busy. If the channel is sensed as busy, indicating another device is currently transmitting, the carrier sensing device will wait for an idle period before attempting to transmit.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication by a wireless node. The method includes detecting, on a first primary channel, a first frame that conveys a response that is part of an initial control frame exchange, and performing a switch to a second primary channel, wherein a timing of the switch is based on at least one rule that depends on whether the apparatus also had detected, on the first primary channel, a second frame that solicited the response.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

The appended figures depict certain features of the various aspects described herein and are not to be considered limiting of the scope of this disclosure.

FIG. 1 shows a pictorial diagram of an example wireless communication network.

FIG. 2 shows a pictorial diagram of an example bandwidth configuration for a wireless local area network (WLAN).

FIGS. 3A and 3B show an example of primary and secondary channel selection for a given channel.

FIGS. 4A and 4B show examples of transmitter and receiver radio resources assignment.

FIG. 5 shows an example timing diagram for a frame exchange that could result in a primary channel switch.

FIG. 6 shows a table illustrating example behavior of a wireless node for primary channel switching in various scenarios.

FIG. 7 shows an example timing diagram for a frame exchange that could result in a primary channel switch.

FIG. 8 shows a diagram illustrating an example process for a primary channel switch, in accordance with aspects of the present disclosure.

FIG. 9 shows an example timing diagram for a primary channel switch, in accordance with aspects of the present disclosure.

FIG. 10 shows an example timing diagram for a primary channel switch, in accordance with aspects of the present disclosure.

FIG. 11 shows a table illustrating example behavior of a wireless node for primary channel switching, in accordance with aspects of the present disclosure.

FIG. 12 shows a flowchart illustrating an example process performable by or at a wireless node.

FIG. 13 shows a block diagram of an example wireless communication device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Various aspects of the present disclosure relate generally to wireless communication and more particularly to techniques for assigning radio resources. For example, the techniques may be used for radio resource switching for wireless nodes that support non-primary channel access (NPCA).

Contention-based channel access generally refers to a mechanism used to share the wireless medium. Devices that want to transmit data first listen to the wireless channel. This procedure is referred to as carrier sensing, where a device first checks if the channel is idle or busy. If the channel is sensed as busy, indicating another device is currently transmitting, the carrier sensing device will wait for an idle period before attempting to transmit.

Contention-based channel access may be used to share access in WLANs that support relatively large bandwidths. For example, IEEE 802.11be Extremely High Throughput (EHT), also known as Wi-Fi 7, has defined bandwidth support for up to 320 MHz. Within the large bandwidth, one 20 MHz channel is designated as a primary channel.

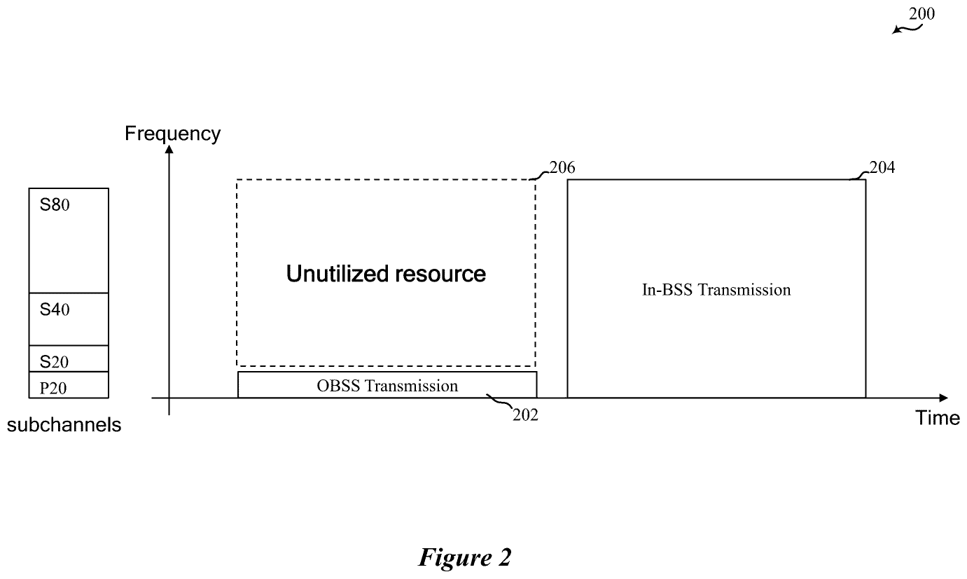

For example, FIG. 2 depicts a diagram 200 for an example bandwidth configuration for a 160 MHz bandwidth, in which the 20 MHz primary channel is labeled P20. A Wi-Fi device contends for access only on the primary channel and access to wider bandwidths (no matter how large) is contingent on access to the primary channel.

Therefore, if an overlapping basic service set (OBSS) STA occupies the primary channel, another (In-BSS) STA may detect an OBSS transmission 202 when performing channel access on the primary channel. Because access to the wider bandwidth (for In-BS transmissions 206) is contingent on access to the primary channel, a remainder of the wide bandwidth 204 remains unutilized, which contributes to lower-throughput and longer latencies.

In some WLAN scenarios, however, a WLAN device may be capable of monitoring additional 20 MHz channel(s) within the operating bandwidth to contend for channel access. In such scenarios, the initial primary channel is referred to as a Main Primary (M-Primary) channel, while an additional 20 MHz channel/subchannel is referred to as an Opportunistic Primary (O-Primary) channel.

Such monitoring for additional 20 MHz channel(s) within the operating bandwidth may be performed sequentially or in parallel. With sequential monitoring, when one 20 MHz primary channel is found Busy, the device switches to another 20 MHz channel to contend for access. When another basic service set (OBSS) transmission is detected on primary channel, the STA may switch to the O-Primary channel and contend for channel access. A STA that supports sequential monitoring may be referred to as a Type-2 device.

With parallel monitoring, the device can monitor multiple 20 MHz channels simultaneously. In some cases, the STA may be capable of detecting preambles and decoding non-HT PPDUs, where such a STA may be referred to as a Type-0 device. In some cases, the STA may be capable of detecting a portion of the 802.11 PPDUs but not capable of decoding PPDUs. Such a STA may be referred to as a Type-1 device.

Certain NPCA STAs (e.g., Type-1 NPCA STAs) may be able to contend and detect incoming packets/PPDUs on multiple primary channels concurrently. However, the STA may be able to transmit or receive 802.11 PPDUs on only one (e.g., NPCA) primary channel at a time.

Thus, if the STAs RBO counts down to zero or if the STA detects a PPDU on a certain primary, then the STA switches to and remains on that primary channel for the duration of the PPDU Tx/Rx. The term “NPCA Primary channel” generally refers to a primary channel (either M-Primary or O-Primary) where an NPCA STA can contend for channel access.

However, once the STA has switched to one primary channel, other events can be triggered on another (e.g., NPCA) primary channel. For example, two packets may be received on different anchors (e.g., at the same time, a small time apart or a large time apart) or the STA may be decoding a packet on one primary while RBO counts down to zero on another primary.

The event that triggers switching to the NPCA primary channel may involve an OBSS Control frame exchange, such as a request-to-send (RTS) and clear-to-send (CTS) exchange, a multi-user (MU) RTS/CTS) exchange, or some other type of trigger fame (e.g., an OBSS HE/EHT/UHR PPDU). After such a trigger event, the switch to an O-primary channel may be performed immediately (or a certain delay, such as a slot duration) after decoding a signal (SIG) field (e.g., the HE-SIG-A/U-SIG field of the OBSS PPDU).

In certain cases, however, a switch may be performed based on an OBSS control frame exchange. In such cases, an initial control frame (ICF) is typically sent to solicit a response in the form of an initial control frame response (ICR). Detecting this OBSS exchange may help ensure that both (In-BSS) devices (e.g., an AP and non-AP STA) are aligned in terms of their switching time. This alignment may be important so they optimize available transmit opportunity (TXOP) time on an O-primary before switching back to the M-primary. For example, if the AP and non-AP STA switch at different times, the two devices may be unable to reach (such as communicate with) each other, thereby causing a loss of coordination between the AP and non-AP STA.

One potential challenge when switching based upon detection of an OBSS control frame exchange is that one device may only detect the response frame and not the soliciting frame. This may occur, for example, due to hidden node scenarios where a STA detects an OBSS ICR, but not the soliciting OBSS ICF. An issue arises in that that STA's peer may receive the OBSS ICF, but not the solicited ICR. In such cases, the timing of the switch to the NPCA Primary channel (O-primary) at the two NPCA peers might be different.

A potential problem of one device switching ton an O-primary channel before a peer device is the device that switches early may send a frame (e.g., an ICF) after switching to confirm (verify) the other device has switched. If it gets no response, it may switch back to the M-primary channel before the other device has switched. As a result, the potential to communicate on the O-primary during an OBSS TXOP on the M-primary may be wasted.

Aspects of the present disclosure provide mechanisms that may help ensure that the timing of the switch at two NPCA peers is aligned. As will be described in greater detail below, one or more rules may be provided that dictate the timing of a switch for a peer STA that only detects a response frame (e.g., an ICR) but not the frame that solicited the response (e.g., an ICF).

Particular aspects of the subject matter described in this disclosure can be implemented to realize one or more of the following potential advantages. In some examples, the described techniques can be used to align the switching of peers to an O-primary channel. Channel selection performed according to techniques proposed herein may help optimize available time during a TXOP.

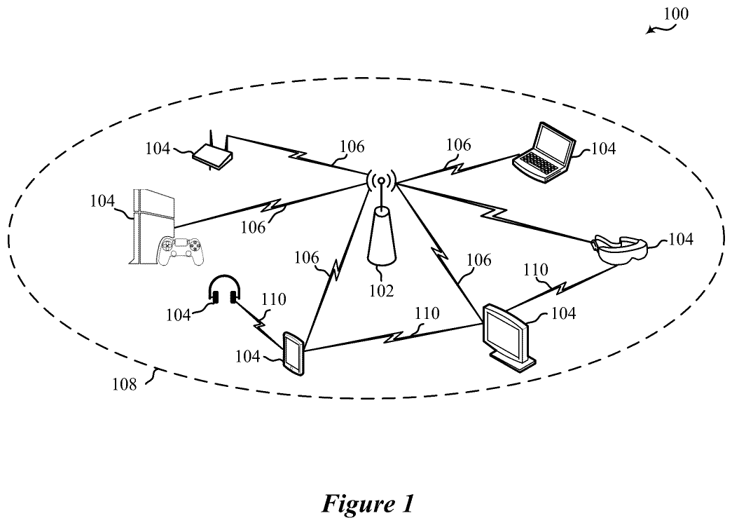

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while an UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of the wireless communication network 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

### Overview of Channel Numbering

A primary channel generally refers to a channel that a STA monitors for contention-based channel access. As described above with reference to FIG. 2, in WLANs that support relatively large bandwidths, one 20 MHz channel is designated as a primary channel. This channel may be referred to as primary 20 or, as labeled in FIG. 2, simply P20.

Selection of the bandwidth for the P20 channel typically decides all other channels. For example, in the case of a 160 MHz operating bandwidth, selection of P20 may determine a secondary 20 MHz channel (S20), a primary 40 MHz channel (P40), a secondary 40 MHz channel (S40), a primary 80 MHz channel (P80), and a secondary 80 MHz channel (S80).

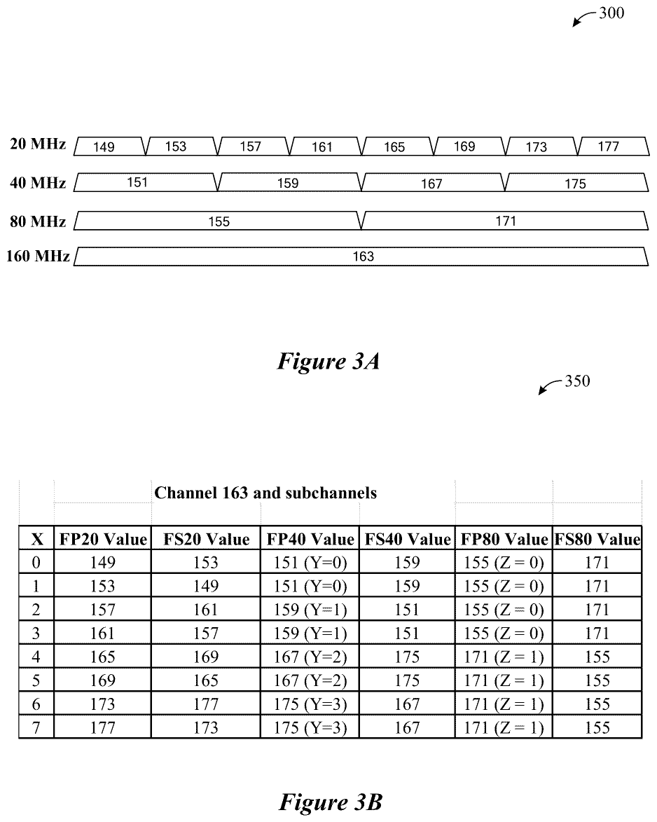

FIGS. 3A and 3B show an example of primary and secondary channel selection for a given channel. Diagram 300 of FIG. 3A shows how the bandwidth of a 160 MHz channel number 163 may be allocated to form different 80 MHz channels (155 and 171), 40 MHz channels (151, 159, 167, and 175), and 20 MHz channels (149, 153, 157, 161, 165, 169, 173, and 177). Particular channel frequencies for these channels may be determined based on a set of equations, determined by the operating bandwidth and a channel selection parameter X.

Table 350 of FIG. 3B shows the possible combinations of channel frequencies for P20, S20, P40, S40, P80, and S80 channels for the 160 MHz bandwidth channel 163 shown in FIG. 3A. As illustrated, selecting the parameter X is essentially the same as choosing the channel frequency for P20. For example, choosing X=1 means P20 is 153 and vice versa, resulting in S20=149, P40=151), S40=159, P80=155, and S80=171.

### Overview of NPCA

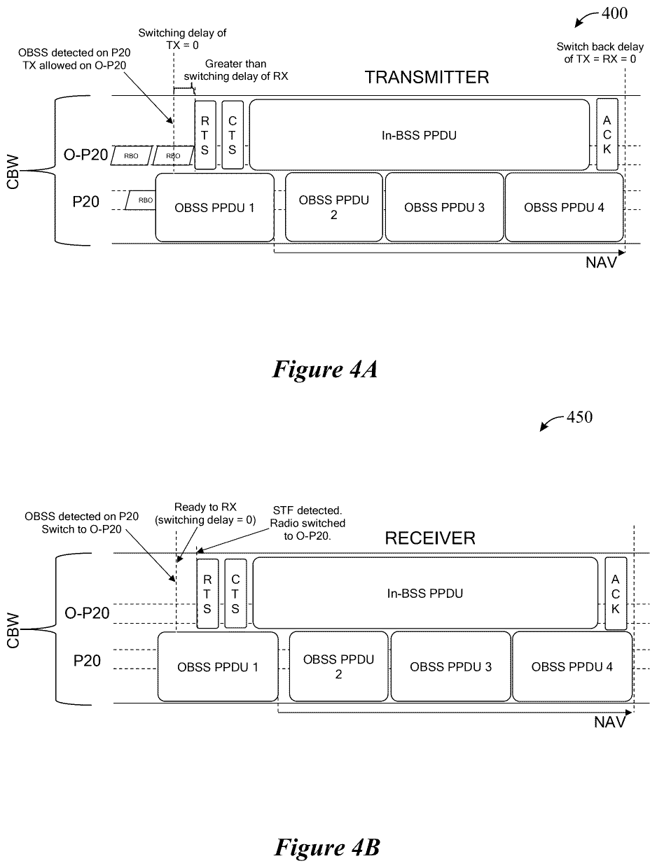

FIG. 4A shows a diagram 400 illustrating an example non-primary channel access (NPCA) STA in a scenario in which transmission is allowed on a non-primary channel (opportunistic primary channel O-P20).

In the illustrated example, while contending for channel access on a first (main) primary channel P20 to send a PPDU, the STA detects an OBSS transmission (PPDU) on P20 (during countdown of a random backoff (RBO) counter. In response, since transmission is allowed on O-P20, the STA switches to O-P20. After contending for (and gaining) access on O-P20, the STA sends an initial control frame (such as request to send (RTS)) and, after receiving the response to the initial control frame (such as a clear to send (CTS)), transmits its (In-BSS) PPDU. As illustrated, the intended recipient may send an acknowledgment (ACK) of receipt of the PPDU.

FIG. 4B shows a diagram 450 illustrating an example non-primary channel access (NPCA) STA in a scenario in which a STA switches to O-P20 for reception.

In the illustrated example, while contending for channel access on P20, the STA again detects an OBSS PPDU on P20. In response, the STA switches to O-P20 and, after a switching delay, is ready to receive on O-P20. After receiving an RTS on O-P20, the STA sends a CTS and receives a PPDU on O-P20. As illustrated, the STA may send an ACK after receiving the PPDU.

### Aspects Related to Rules for Switching of the STAs

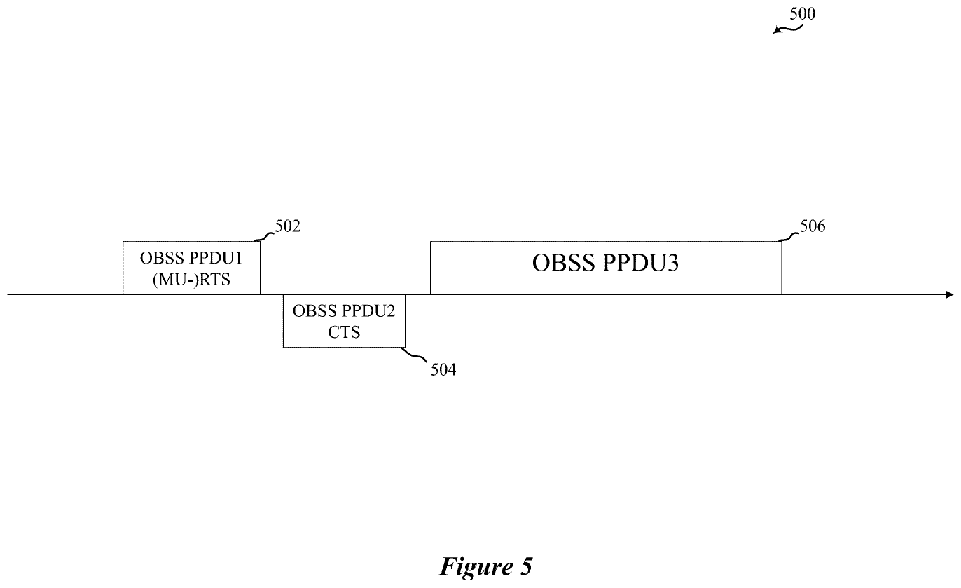

As noted above, an OBSS Control frame exchange may trigger an NPCA STA switch. For example, a NPCA STA switch may be triggered by an (MU-)RTS/CTS exchange as shown in diagram 500 of FIG. 5.

In some cases, if an NPCA STA receives (detects) the OBSS (MU-) RTS 502 and the OBSS CTS 504, it may perform a switch to an O-primary according to a defined timing.

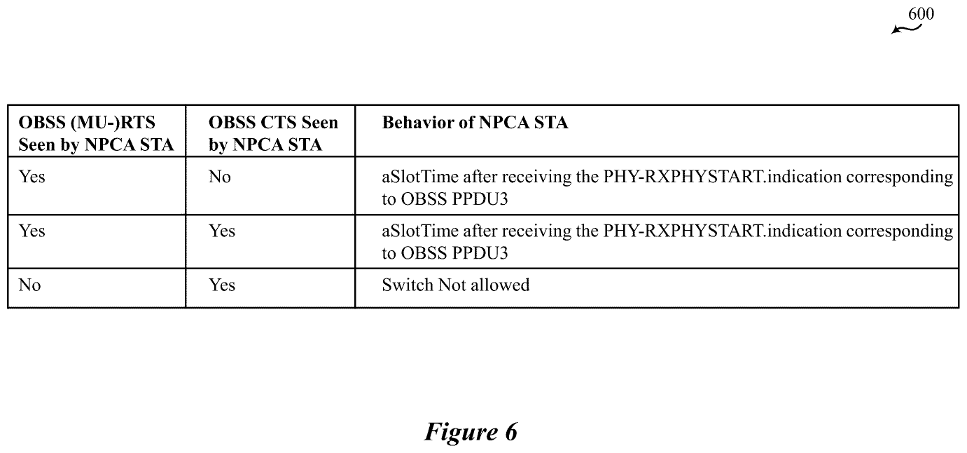

For example, as indicated in table 600 of FIG. 6, the NPCA STA may switch a slot time after receiving a start indication (e.g., PHY-RXPHYSTART. indication) corresponding to a subsequent OBSS PPDU (e.g., OBSS PPDU3 506 in FIG. 5). This timing approach may help ensure the OBSS PPDU is actually going to take place on the M-primary (providing the opportunity to switch to the O-primary). As illustrated, in some cases, an NPCA STA may switch according to the same timing after receiving the (MU-) RTS even if it does not receive the CTS.

In certain systems, however, if an NPCA STA detects an OBSS CTS frame 504 (e.g., in a non-HT duplicate PPDU) without receiving the soliciting OBSS RTS or MU-RTS frame, the NPCA STA may not be allowed to switch to the NPCA Primary channel. The logic behind this rule may be to keep a STA from switching when it is unsure when or if its peer (e.g., an AP) will switch and/or when the STA is unable to determine the bandwidth of the PPDU that contains the OBSS CTS frame.

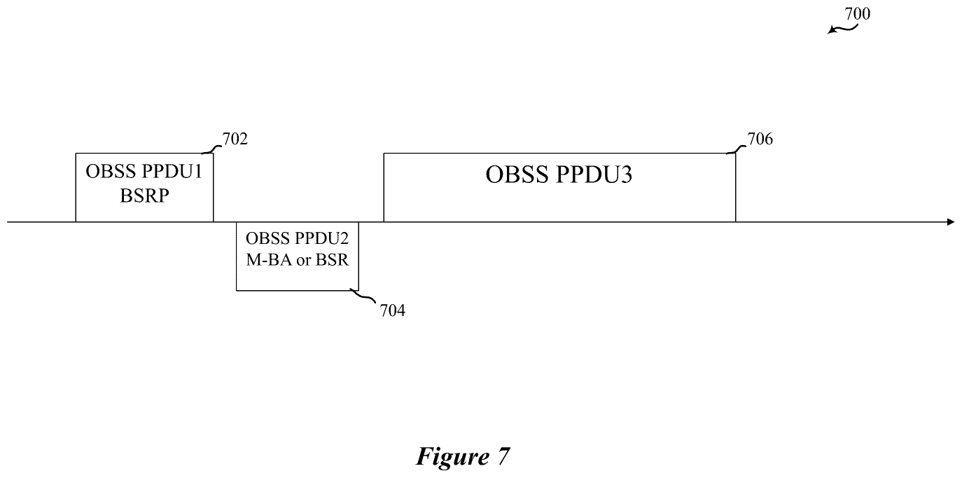

A similar case may occur in scenarios when an NPCA switch is triggered by an OBSS control frame exchange. As illustrated in diagram 700 of FIG. 7, an example of an OBSS control frame exchange may be an OBSS PPDU1, such as a trigger frame of type buffer status report poll (BSRP) 702 which may be referred to as a BSRP that solicits an OBSS multi-station block acknowledgment (M-BA) or buffer status report (BSR) 704.

In some cases, an NPCA STA that detects the BSRP 702 may switch a slot time after receiving a start indication (e.g., a PHY-RXPHYSTART indication) corresponding to a subsequent OBSS PPDU 706. This switch may occur regardless of whether the NPCA STA detects the response frame (e.g., BSR) 704.

In other cases, an NPCA STA may only detect the response frame (e.g., BSR) 704 and not the soliciting frame (e.g., BSRP) 702. This may occur, for example, in certain hidden node scenarios where a STA detects an OBSS ICR, but not the soliciting OBSS ICF.

As noted above, the NPCA STA's peer STA may detect the soliciting frame (e.g., BSRP) 702, which may result in the timing of the switch to the O-primary at the two NPCA peers being different.

A potential problem of one device switching to an O-primary channel before a peer device is the device that switches early may send a frame (e.g., an ICF) after switching to confirm (verify) the other device has switched. If it gets no response, it may conclude that the peer STA has not switched and, therefore, switch back to the M-primary channel before the other device has switched. As a result, the potential to communicate on the O-primary during an OBSS TXOP on the M-primary may be wasted.

In FIG. 7, the BSR or M-BA may be conveyed in a TB PPDU (e.g., an HE/EHT/UHR PPDU). This implies that NPCA STAs will need different switching behavior for HE/EHT/UHR PPDU based on the “contents” of the PPDU, i.e., based on whether the TB PPDU contains a BSR frame, an M-BA frame, or not.

For example, if the PPDU contains a BSR or M-BA, the NPCA STA may switch after defined time after the start of the subsequent OBSS PPDU (e.g., PPDU3 706 in FIG. 7). On the other hand, if the PPDU does not contain a BSR or M-BA, the NPCA STA may switch immediately (or a slot time) after decoding the U-SIG or HE-SIG-A field.

This may result in undue complexity, where switching rules may be different for the same PPDU type. Further, this approach may involve looking (peeking) into the PSDU, because decoding the MAC header may not be possible (e.g., because of MCS mismatch, i.e., the NPCA STA not having sufficient SNR to decode the frame carried in the PPDU and/or inability to infer which RUs to decode because the soliciting frame that allocates (such as assigns) these RUs is not received).

Aspects of the present disclosure provide mechanisms that may help ensure that the timing of the switch at two NPCA peers is aligned. As will be described in greater detail below, one or more rules may be provided that dictate the timing of an NPCA switch for a peer STA that only detects a response frame but not the frame that solicited the response. In some examples, the described techniques can be used to try and align the switching of peers to an O-primary channel.

In some cases, where only a response frame (of an OBSS control frame exchange) is detected without detecting the soliciting frame, NPCA switching may be precluded. This approach may not be desirable because, for the STA to execute this rule, it may need to infer that the received frame is an M-BA/BSR, which may require decoding the PSDU in an HE/EHT/UHR PPDU.

Without any special handling of BSR/M-BA in a TB PPDU, the NPCA STA will treat it as any other HE/EHT/UHR PPDU. Thus, there may be a switch immediately (or a slot time) after U-SIG or the HE-SIG-A field of the TB PPDU. This may imply that the NPCA STA that receives a BSR/M-BA without receiving the soliciting BSRP will switch sooner than a STA that receives the soliciting BSRP. Thus, if an AP hears a BSRP but the non-AP STA hears (only the) BSR, the non-AP STA may switch sooner than the AP. Aspects of the present disclosure may help address this asynchronous switching to an NPCA Primary.

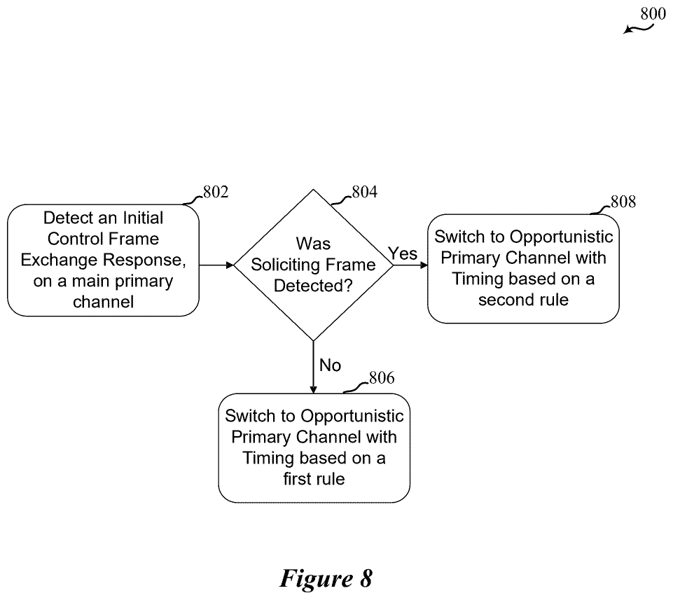

FIG. 8 shows a diagram 800 illustrating an example process for NPCA switching, in accordance with this first option. This option may effectively acknowledge that a set of NPCA peers may switch at different times.

As illustrated at 802, the example assumes the NPCA STA detects an Initial Control Frame Exchange Response, on a main primary channel (M-primary).

In response, the NPCA STA may switch to the opportunistic primary channel (O-primary), with the timing of the switch determined based on whether the frame that solicited the response was detected (as determined at 804).

For example, as indicated at 806, if the soliciting frame was detected, the switch may be based on a first rule. If the soliciting frame was not detected, as indicated at 808, the switch may be based on a second rule.

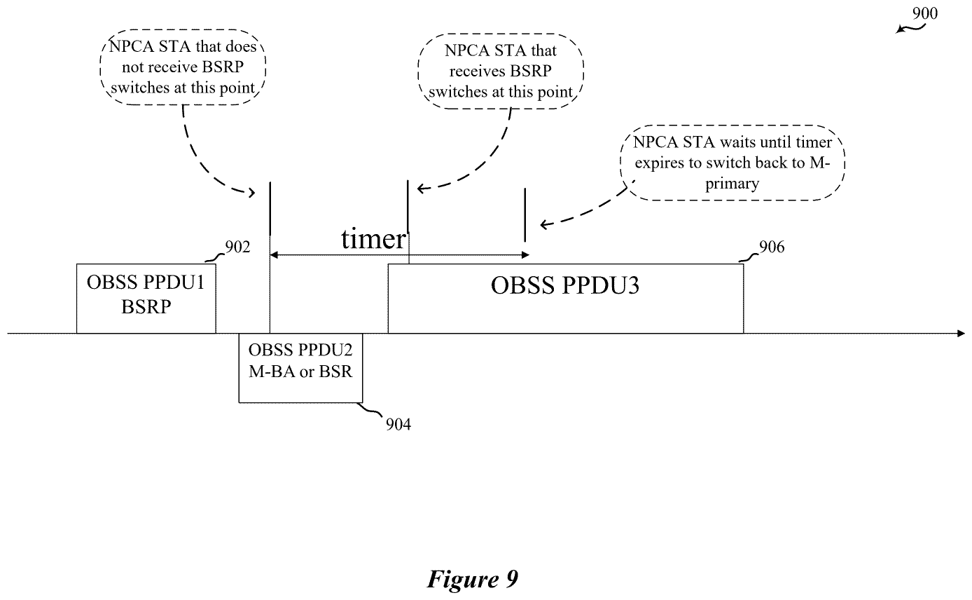

One example of different such rules in illustrated in diagram 9 of FIG. 9. The example illustrates an OBSS control frame exchange including a BSRP 902 and an M-BA or BSR 904 that precede an OBSS PPDU3 906.

As indicated, an NPCA STA that does not detect the BSRP 902, but does detect the M-BA or BSR 904, may switch immediately (e.g., after detecting the U-SIG field or the HE-SIG-A field of the PPDU carrying the M-BA or BSR frame 904). On the other hand, an NPCA STA that does detect the BSRP 902 may switch later (e.g., after a start of the OBSS PPDU3 906).

As noted above, one potential problem is that the STA that switched to O-primary early may not reach (e.g., may not communicate with) its peer STA that switches later and may, thus, conclude that the peer STA has not switched and switch back to M-primary prematurely. One potential solution to this problem is for the AP to announce a timer value. This timer value may prevent the STA that switched to O-primary early from switching back to M-primary. For example, after a non-AP STA switches to the O-primary if that non-AP STA transmits an initial control frame and does not receive a response, it may wait at least until the timer expires before initiating a switch back to the M-primary.

According to certain aspects, this timer may start immediately after an NPCA STA initiates switch to O-primary channel or it could start immediately after the NPCA STA completes the switch to the O-Primary channel.

According to certain aspects, the AP may announce this timer with a sufficiently large (duration) value such that even if a non-AP STA switches sooner and sends an unsuccessful ICF one or more times, the non-AP STA may not switch back to the M-primary channel until the AP switches to O-Primary and is able to communicate with the non-AP STA.

The AP may account for the non-AP STA's potential early switch to the O-Primary channel while announcing the timer value. As an example, if the AP intends to use a value of 500 usec for the timer, it may instead use a larger value of the timer (e.g., 600 usec) to account for non-AP STA's potential early switch and one or more unsuccessful attempts of the ICF. In some cases, the timer value may be announced during association, in beacons/probe response frames, and/or using the critical update framework.

The example shown in FIG. 9 may assume that upon receiving the HE/EHT/UHR TB PPDU, the NPCA STA uses the PPDU Length and the transmit opportunity (TXOP) length/duration (e.g., that is used to set the network allocation vector or NAV) to determine the duration of OBSS activity (so it can know how long to stay on the O-primary and when to switch back to M-primary). The PPDU length may be indicated, for example, in a legacy SIG (L-SIG) field of the PPDU while a TXOP duration may be indicated in a U-SIG field or the HE-SIG-A field of the PPDU.

Instead, if a PPDU-based switch only uses PPDU Length to determine the duration of OBSS activity, an NPCA STA may likely not switch to O-Primary based on reception of a TB PPDU alone (e.g., the PPDU length may not be sufficiently long to justify the switch). Thus, the NPCA may only switch if the OBSS activity duration is above a threshold value (e.g., PPDU length+TXOP duration>OBSS_activity_threshold). According to certain aspects, an AP may set the OBSS activity threshold to be greater than the length of a typical TB PPDU that carries the M-BA/BSR frame. In some cases, the OBSS activity threshold value may be announced during association, in beacons/probe response frames, and/or using the critical update framework.

According to certain aspects, NPCA switching may be disabled if the OBSS HE/EHT/UHR PPDU is a TB PPDU. As an alternative, NPCA switching may be allowed for TB PPDUs greater than X usec, where X may be announced by the AP during association, in beacons/probe response frames, and/or using the critical update framework.

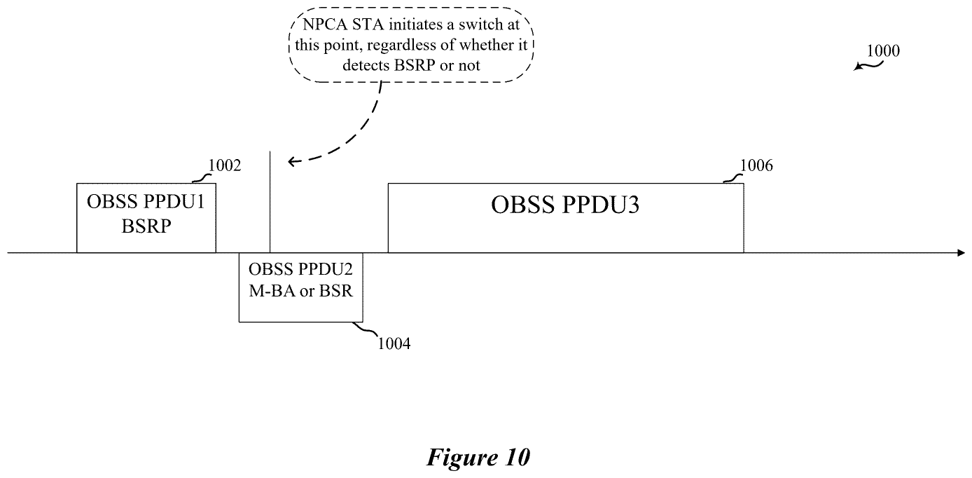

According to certain aspects, separate switch time rules may be provided for the BSRP/BSR exchange case. For example, as illustrated in diagram 1000 of FIG. 10, instead of waiting until PPDU3 1006 to confirm that the OBSS BSRP 1002/BSR 1004 exchange is complete, both NPCA STAs may switch to the O-primary channel immediately (or a slot time) after the U-SIG field or HE-SIG-A field of the PPDU carrying the BSR or M-BA frame (regardless of whether they hear the PPDU carrying the BSRP frame or not).

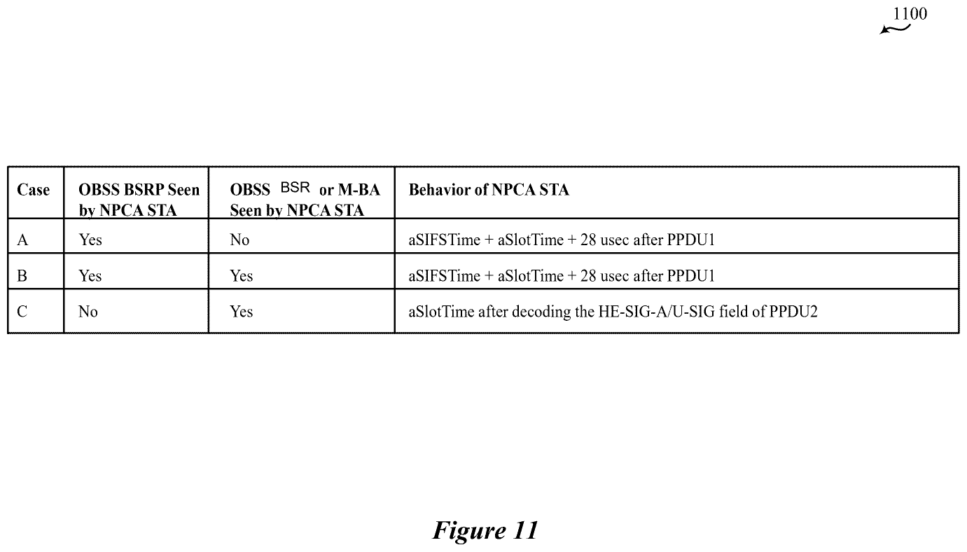

As illustrated in table 1100 of FIG. 11, for this option an NPCA STA that detects the OBSS BSRP may perform a switch a first defined duration (e.g., aSIFSTime+aSlotTime+28 usec or aSIFSTime+aSlotTime+aRxPHYStartDelay) after the end of PPDU1. As illustrated, in the case that an NPCA STA detects the PPDU carrying the OBSS BSR frame without detecting the BSRP, the NPCA STA may perform the switch a second defined duration (e.g., aSlotTime) after decoding the HE-SIG-A or U-SIG field of PPDU2. This second duration may be selected to be much shorter than the first duration in an attempt to at least somewhat align the switching time for NPCA STAs whether or not they detect the BSRP.

According to certain aspects, a TB PPDU (e.g., UHR onwards TB PPDU) may include an explicit indication that it is part of an OBSS Control frame exchange (such that it is a response to an initial Control frame). This explicit indication may be carried in the U-SIG field or some other portion of the PHY preamble, so that NPCA STA does not need to decode the PSDU portion corresponding to the PPDU.

The NPCA STA can use this indication to determine the timing for its NPCA switching. If the explicit indication is present, the NPCA STA may defer its switching. For example, instead of switching immediately after the U-SIG field, the NPCA STA may switch a set duration (e.g., aSIFSTime+aSlotTime+aRxPHYStartDelay) after the end of the TB PPDU. On the other hand, if the explicit indication is not present, the NPCA STA may switch immediately or after a slot time after decoding the U-SIG field.

According to certain aspects, instead of one OBSS activity threshold, an AP may advertise two thresholds. A first threshold (Threshold-1) may indicate a total OBSS activity, while a second threshold (Threshold-2) may be for a PPDU duration. These thresholds may be used to formulate rules for NPCA STA switching.

For example, before an NPCA STA switches to the O-Primary channel it may need to verify that both of the following conditions are met:
Condition 1: The total OBSS activity, as indicated by the PPDU length (if applicable) +TXOP length is greater than Threshold-1;
Condition 2: The length of the PPDU that provides the total OBSS activity is greater than Threshold-2.

If either of the above conditions is not met, the NPCA STA may not be allowed to switch to the O-Primary channel. In some cases, the Threshold_1 value, Threshold_2 value, or both, may be announced during association, in beacons/probe response frames, and/or using the critical update framework.

According to certain aspects, for a UHR/EHT/HE PPDU, the switching rules may be defined. According to a first rule, if the HE/EHT/UHR PPDU is not a Trigger-based PPDU, the NPCA STA may switch immediately or a slot time after the HE-SIG-A/U-SIG field of the PPDU.

According to a second rule, if the HE/EHT/UHR PPDU is a Trigger-based PPDU, when or how switching is performed may be according to different cases. According to a first case, if L-SIG is small and TXOP is large, then the NPCA STA may initiate a switch at the end of L-SIG time (e.g., at the end of the PPDU). Alternatively, the NPCA STA may initiate the switch at set duration (e.g., aSIFSTime+aSlotTime+aRxPHYStartDelay) after the end of the PPDU (e.g., where aRxPHYStartDelay may be set to 20 usec, 28 usec, or a value that is determined according to a PPDU type, such as aRxPHYStartDelay). In some cases, the threshold values for the small and large values may be announced by the AP during association, in beacons/probe response frames, and/or using the critical update framework.

According to a second case, if L-SIG and TXOP are small, the NPCA may not be allowed to switch. According to a third case, if the L-SIG is large and TXOP is small, the NPCA STA may initiate the switch immediately or a time duration after (e.g., a slot time after) HE-SIG-A/U-SIG field of the PPDU.

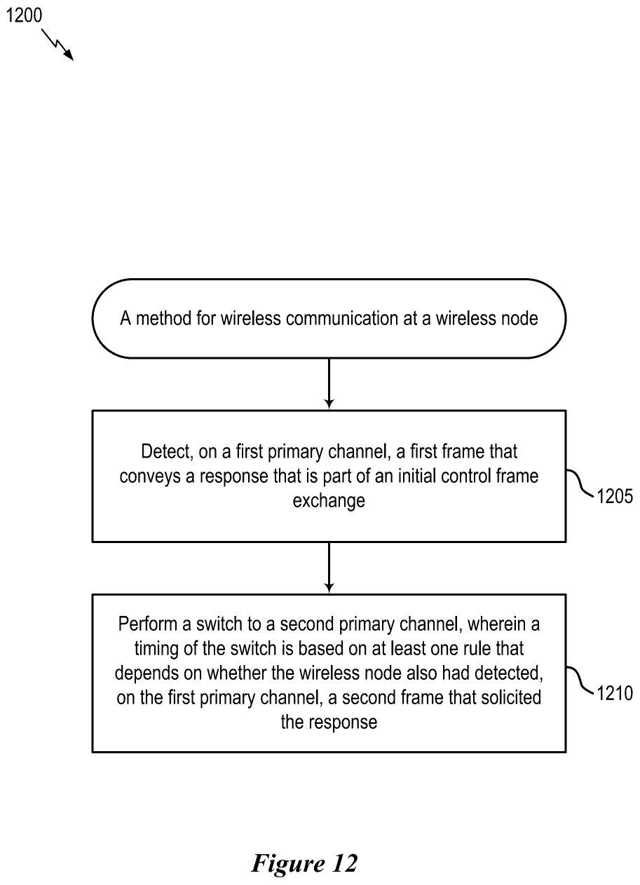

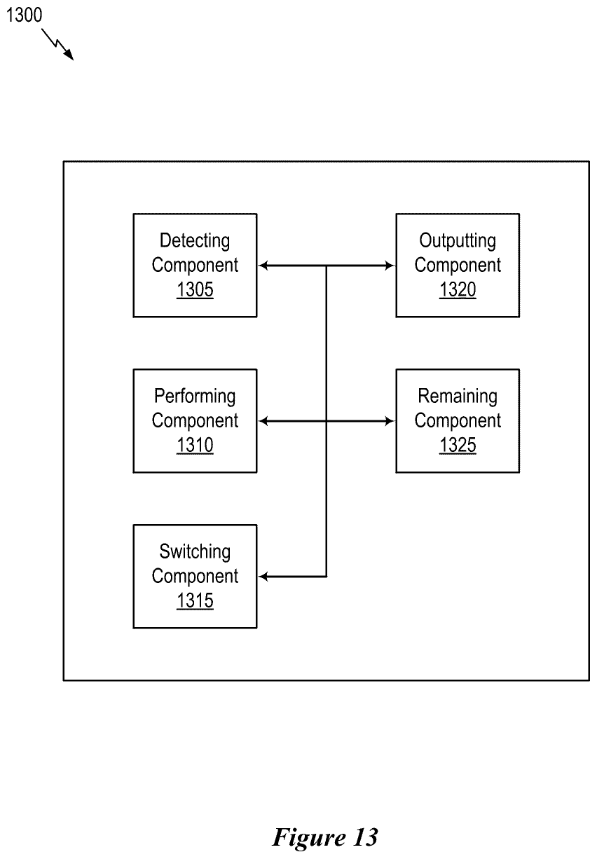

FIG. 12 shows a flowchart illustrating an example process 1200 performable by or at a wireless node. The operations of the process 1200 may be implemented by a wireless STA, or its components as described herein, and/or wireless AP, or its components as described herein. For example, the process 1200 may be performed by a wireless communication device, such as the wireless communication device 1300 described with reference to FIG. 13, operating as or within a wireless STA or operating as or within a wireless AP. In some examples, the process 1200 may be performed by a wireless STA such as one of the STAs 104 described with reference to FIG. 1. In some examples, the process 1200 may be performed by a wireless AP such as one of the APs 102 described with reference to FIG. 1.

In some examples, in block 1205, the wireless node may detect, on a first primary channel, a first frame that conveys a response that is part of an initial control frame exchange. In some cases, the operations of this step refer to, or may be performed by, a detecting component as described with reference to FIG. 13.

In some examples, in block 1210, the wireless node may perform a switch to a second primary channel, wherein a timing of the switch is based on at least one rule that depends on whether the wireless node also had detected, on the first primary channel, a second frame that solicited the response. In some cases, the operations of this step refer to, or may be performed by, a performing component as described with reference to FIG. 13.

In some aspects, the first primary channel comprises a main primary channel; and the second primary channel comprises an opportunistic primary channel.

In some aspects, the response comprises: a Multi-Block Acknowledgement (M-BA); or a buffers status report (BSR).

In some aspects, the at least one rule specifies that: the switch is initiated after detecting a portion of the first frame, if the wireless node does not detect the second frame.

In some aspects, the process 1200 further includes switching back to the first primary channel, wherein the at least one rule further specifies that the switch back to the first primary channel is subject to expiration of a timer. In some cases, the operations of this step refer to, or may be performed by, a switching component as described with reference to FIG. 13.

In some aspects, the process 1200 further includes outputting an initial control frame (ICF) after the switch to the second primary channel. In some cases, the operations of this step refer to, or may be performed by, an outputting component as described with reference to FIG. 13.

In some aspects, the process 1200 further includes remaining on the second primary channel until expiration of the timer and independent of whether a response to the ICF is obtained. In some cases, the operations of this step refer to, or may be performed by, a remaining component as described with reference to FIG. 13.

In some aspects, the portion comprises a universal signal (U-SIG) field or high efficiency signal (HE-SIG) field; and the at least one rule specifies that the switch is initiated a time period after detecting the portion, if the wireless node does not detect the second frame.

In some aspects, the portion comprises a universal signal (U-SIG) field; and the at least one rule specifies that the switch is initiated a time period after detecting the portion, if: the first frame includes an indication the first frame is part of the initial control frame exchange; and the wireless node does not detect the second frame.

In some aspects, the process 1200 further includes performing a switch back to the first primary channel. In some cases, the operations of this step refer to, or may be performed by, a performing component as described with reference to FIG. 13.

In some aspects, the process 1200 further includes detecting, on the first primary channel, a trigger-based physical layer protocol data unit (PPDU). In some cases, the operations of this step refer to, or may be performed by, a detecting component as described with reference to FIG. 13.

In some aspects, the process 1200 further includes performing another switch to the second primary channel based on at least one other rule that depends on a duration of the trigger-based PPDU and a transmit opportunity (TXOP) duration. In some cases, the operations of this step refer to, or may be performed by, a performing component as described with reference to FIG. 13.

In some aspects, the process 1200 further includes performing a switch back to the first primary channel. In some cases, the operations of this step refer to, or may be performed by, a performing component as described with reference to FIG. 13.

In some aspects, the process 1200 further includes detecting, on the first primary channel, a trigger-based physical layer protocol data unit (PPDU). In some cases, the operations of this step refer to, or may be performed by, a detecting component as described with reference to FIG. 13.

In some aspects, the process 1200 further includes performing another switch to the second primary channel if a length of the trigger-based PPDU meets at least one condition relative to a threshold. In some cases, the operations of this step refer to, or may be performed by, a performing component as described with reference to FIG. 13.

In some aspects, the at least one rule further specifies that: the switch is initiated only if a length of the first frame meets at least one condition relative to a threshold.

In some aspects, the at least one rule further specifies that the switch is initiated only based on: a sum of a transmit opportunity (TXOP) duration and a duration of the first frame is greater than or equal to a first threshold; and a length of the first frame is greater than or equal to a second threshold.

Note that FIG. 12 is just one example of a process, and other processes including fewer, additional, or alternative steps are possible consistent with this disclosure.

FIG. 13 shows a block diagram of an example wireless communication device 1300. In some examples, the wireless communication device 1300 is configured to perform the process 1200 described with reference to FIG. 12. The wireless communication device 1300 may include one or more chips, SoCs, chipsets, packages, components or devices that individually or collectively constitute or include a processing system. The processing system may interface with other components of the wireless communication device 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1300 may transmit the information output from the chip. In such an example, the second interface may refer to an interface between the processing system of the chip and a reception component, such that the device 1300 may receive information that is passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be configurable or configured for use in a STA, such as the STA 104 described with reference to FIG. 1. In some other examples, the wireless communication device 1300 can be a STA that includes such a processing system and other components including multiple antennas. In some examples, the wireless communication device 1300 can be configurable or configured for use in an AP, such as the AP 102 described with reference to FIG. 1. In some other examples, the wireless communication device 1300 can be an AP that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes a user interface (UI) (such as a touchscreen or keypad) and a display, which may be integrated with the UI to form a touchscreen display that is coupled with the processing system. In some examples, the wireless communication device 1300 may further include one or more sensors such as, for example, one or more inertial sensors, accelerometers, temperature sensors, pressure sensors, or altitude sensors, that are coupled with the processing system. In some examples, the wireless communication device 1300 further includes at least one external network interface coupled with the processing system that enables communication with a core network or backhaul network that enables the wireless communication device 1300 to gain access to external networks including the Internet.

The wireless communication device 1300 includes detecting component 1305, performing component 1310, switching component 1315, outputting component 1320, and remaining component 1325. Portions of one or more of the components 1305, 1310, 1315, 1320, and 1325 may be implemented at least in part in hardware or firmware. For example one or more of the components 1305, 1310, 1315, 1320, and 1325 may be implemented at least in part by a processor or a modem. In some examples, portions of one or more of the components 1305, 1310, 1315, 1320, and 1325 may be implemented at least in part by a processor and software in the form of processor-executable code stored in a memory.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as AP 102s and STA 104s) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

### EXAMPLE CLAUSES

Implementation examples are described in the following numbered clauses.

Clause 1: A method for wireless communication at a wireless node, including: detecting, on a first primary channel, a first frame that conveys a response that is part of an initial control frame exchange; and performing a switch to a second primary channel, wherein a timing of the switch is based on at least one rule that depends on whether the wireless node also had detected, on the first primary channel, a second frame that solicited the response.

Clause 2: The method of Clause 1, where the first primary channel includes a main primary channel; and the second primary channel includes an opportunistic primary channel.

Clause 3: The method any one of Clauses 1-2, where the response includes: a Multi-Block Acknowledgement (M-BA); or a buffers status report (BSR).

Clause 4: The method any one of Clauses 1-3, where the at least one rule specifies that: the switch is initiated after detecting a portion of the first frame, if the wireless node does not detect the second frame.

Clause 5: The method of Clause 4, further including: switching back to the first primary channel, wherein the at least one rule further specifies that the switch back to the first primary channel is subject to expiration of a timer.

Clause 6: The method of Clause 5, further including: outputting an initial control frame (ICF) after the switch to the second primary channel; and remaining on the second primary channel until expiration of the timer and independent of whether a response to the ICF is obtained.

Clause 7: The method of Clause 4, where the portion includes a universal signal (U-SIG) field or high efficiency signal (HE-SIG) field; and the at least one rule specifies that the switch is initiated a time period after detecting the portion, if the wireless node does not detect the second frame.

Clause 8: The method of Clause 4, where the portion includes a universal signal (U-SIG) field; and the at least one rule specifies that the switch is initiated a time period after detecting the portion, if: the first frame includes an indication the first frame is part of the initial control frame exchange; and the wireless node does not detect the second frame.

Clause 9: The method of Clause 4, further including: performing a switch back to the first primary channel; detecting, on the first primary channel, a trigger-based physical layer protocol data unit (PPDU); and performing another switch to the second primary channel based on at least one other rule that depends on a duration of the trigger-based PPDU and a transmit opportunity (TXOP) duration.

Clause 10: The method of Clause 4, further including: performing a switch back to the first primary channel; detecting, on the first primary channel, a trigger-based physical layer protocol data unit (PPDU); and performing another switch to the second primary channel if a length of the trigger-based PPDU meets at least one condition relative to a threshold.

Clause 11: The method any one of Clauses 1-10, where the at least one rule further specifies that: the switch is initiated only if a length of the first frame meets at least one condition relative to a threshold.

Clause 12: The method any one of Clauses 1-11, where the at least one rule further specifies that the switch is initiated only based on: a sum of a transmit opportunity (TXOP) duration and a duration of the first frame is greater than or equal to a first threshold; and a length of the first frame is greater than or equal to a second threshold.

Clause 13: An apparatus, including: at least one memory including executable instructions; and at least one processor configured to execute the executable instructions and cause the apparatus to perform a method in accordance with any combination of Clauses 1-12.

Clause 14: An apparatus, including means for performing a method in accordance with any combination of Clauses 1-12.

Clause 15: A non-transitory computer-readable medium including executable instructions that, when executed by at least one processor of an apparatus, cause the apparatus to perform a method in accordance with any combination of Clauses 1-12.

Clause 16: A computer program product embodied on a computer-readable storage medium including code for performing a method in accordance with any combination of Clauses 1-12.

Clause 17: A wireless node (e.g., a access point (AP) entity or a wireless station (STA)), including: at least one transceiver; at least one memory including executable instructions; and at least one processor configured to execute the executable instructions and cause the wireless node to perform a method in accordance with any combination of Clauses 1-12, wherein the at least one transceiver is configured to detect the first frame.

### ADDITIONAL CONSIDERATIONS

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

Means for detecting, means for performing, means for switching, means for outputting, means for remaining, and means for obtaining may comprise one or more processors (e.g., the one or more processors/components illustrated in the figures and/or described above), such as the processor(s) described above with reference to FIG. 13.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising instructions; and
one or more processors configured to execute the instructions to cause the apparatus to:
detect, on a first primary channel, a first frame that conveys a response that is part of an initial control frame exchange; and
perform a switch to a second primary channel, wherein a timing of the switch is based on at least one rule that depends on whether the apparatus also had detected, on the first primary channel, a second frame that solicited the response.

2. The apparatus of claim 1, wherein:
the first primary channel comprises a main primary channel; and
the second primary channel comprises an opportunistic primary channel.

3. The apparatus of claim 1, wherein the response comprises:
a Multi-Block Acknowledgement (M-BA); or a buffers status report (BSR).

4. The apparatus of claim 1, wherein the at least one rule specifies that:
the switch is initiated after detecting a portion of the first frame, if the apparatus does not detect the second frame.

5. The apparatus of claim 4, wherein:
the one or more processors are further configured to execute instructions to cause the apparatus to switch back to the first primary channel; and
the at least one rule further specifies that the switch back to the first primary channel is subject to expiration of a timer.

6. The apparatus of claim 5, wherein the one or more processors are further configured to execute instructions to cause the apparatus to:
output an initial control frame (ICF) after the switch to the second primary channel; and
remain on the second primary channel until expiration of the timer and independent of whether a response to the ICF is obtained.

7. The apparatus of claim 4, wherein:
the portion comprises a universal signal (U-SIG) field or high efficiency signal (HE-SIG) field; and
the at least one rule specifies that the switch is initiated a time period after detecting the portion, if the apparatus does not detect the second frame.

8. The apparatus of claim 4, wherein:
the portion comprises a universal signal (U-SIG) field; and
the at least one rule specifies that the switch is initiated a time period after detecting the portion, if:
the first frame includes an indication the first frame is part of the initial control frame exchange; and
the apparatus does not detect the second frame.

9. The apparatus of claim 4, wherein the one or more processors are further configured to execute the instructions to cause the apparatus to:
perform a switch back to the first primary channel;
detect, on the first primary channel, a trigger-based physical layer protocol data unit (PPDU); and
perform another switch to the second primary channel based on at least one other rule that depends on a duration of the trigger-based PPDU and a transmit opportunity (TXOP) duration.

10. The apparatus of claim 4, wherein the one or more processors are further configured to execute the instructions to cause the apparatus to:
perform a switch back to the first primary channel;
detect, on the first primary channel, a trigger-based physical layer protocol data unit (PPDU); and
perform another switch to the second primary channel if a length of the trigger-based PPDU meets at least one condition relative to a threshold.

11. The apparatus of claim 1, wherein the at least one rule further specifies that:
the switch is initiated only if a length of the first frame meets at least one condition relative to a threshold.

12. The apparatus of claim 1, wherein the at least one rule further specifies that the switch is initiated only based on:
a sum of a transmit opportunity (TXOP) duration and a duration of the first frame is greater than or equal to a first threshold; and
the length of the first frame is greater than or equal to a second threshold.

13. A method for wireless communication at a wireless node, comprising:
detecting, on a first primary channel, a first frame that conveys a response that is part of an initial control frame exchange; and
performing a switch to a second primary channel, wherein a timing of the switch is based on at least one rule that depends on whether the wireless node also had detected, on the first primary channel, a second frame that solicited the response.

14. The method of claim 13, wherein:
the first primary channel comprises a main primary channel; and
the second primary channel comprises an opportunistic primary channel.

15. The method of claim 13, wherein the response comprises:
a Multi-Block Acknowledgement (M-BA); or
a buffers status report (BSR).

16. The method of claim 13, wherein the at least one rule specifies that:
the switch is initiated after detecting a portion of the first frame, if the wireless node does not detect the second frame.

17. The method of claim 16, further comprising switching back to the first primary channel, wherein the at least one rule further specifies that the switch back to the first primary channel is subject to expiration of a timer.

18. The method of claim 17, further comprising:
outputting an initial control frame (ICF) after the switch to the second primary channel; and
remaining on the second primary channel until expiration of the timer and independent of whether a response to the ICF is obtained.

19. The method of claim 16, wherein:
the portion comprises a universal signal (U-SIG) field or high efficiency signal (HE-SIG) field; and
the at least one rule specifies that the switch is initiated a time period after detecting the portion, if the wireless node does not detect the second frame.

20. A wireless node, comprising:
at least one transceiver, at least one memory comprising instructions, one or more processors configured to execute the instructions to cause the wireless node to:
receive, via the at least one transceiver on a first primary channel, a first frame that conveys a response that is part of an initial control frame exchange;
and perform a switch to a second primary channel, wherein a timing of the switch is based on at least one rule that depends on whether the wireless node also had received, on the first primary channel, a second frame that solicited the response.
